(19) United States
(12) Patent Application Publication
(10) Pub. No.: US 2014/0057116 A1
(43) Pub. Date: Feb. 27, 2014

(54) COATED FIBROUS BASED SUBSTRATES

(71) Applicant: Darryl Cassingham, Somerset (GB)

(72) Inventor: Darryl Cassingham, Somerset (GB)

(73) Assignee: NORTHANTS LEATHER CHEMICALS LTD, Northamptonshire (GB)

(21) Appl. No.: 14/000,321

(22) PCT Filed: Feb. 16, 2012
(86) PCT No.: PCT/IB12/50722

§ 371 Date: Nov. 8, 2013

(30) Foreign Application Priority Data
Feb. 24, 2011 (GB) 1103177.0

(51) Int. Cl. C14C 3/28; D06M 11/56; D06M 11/57; C14C 11/00; C14C 3/04; C14C 9/04; C14C 9/02; B65D 77/22; D06N 3/14

(52) U.S. Cl. CPC C14C 3/28; B65D 77/22; D06M 11/56; D06M 11/57; D06N 3/14; C14C 3/04; C14C 9/04; C14C 9/02; C14C 11/00
USPC 428/413; 428/447; 220/500; 427/302

(57) ABSTRACT

Coated Fibrous Substrates The present invention provides a method of improving the adhesion of coatings to fibrous base materials. The method comprises treating a fibrous base material with one or more salt(s) of receptor species to provide a pre-coated fibrous base material comprising specific inorganic receptor sites within the fibrous base material. The one or more salt(s) of receptor species is selected from the groups comprising: (a) aluminium salts; (b) titanium salts; (c) zirconium salts; (d) iron salts; (e) soluble alkali silicates; or a combination thereof. The method further comprises coating the treated fibrous base material with a coating formulation comprising one or more compound(s) containing epoxy and alkoxysilane groups. The coating formulation acts as an adhesion promoter and cross-linker.

The present invention relates to methods of improving the adhesion of coatings to fibrous base materials.

It is well known that the leather and textile industry require high performance coating systems in the creation of products which must meet very strict technical performance criteria. Such coating systems may utilise a fibrous base material that is of either natural or synthetic fibres, or indeed both, and can be either non-woven, woven, hydro-entangled or created through some other method.

For example, dual-component aqueous based coating compositions containing various resinous based binders (e.g. polyurethane, acrylic, etc.) and a cross-linker (e.g. polyisocyanate, polyaziridine, polycarbodiimide, etc.) are known and extensively used within the leather and textiles industry. However, these existing systems suffer from a number of disadvantages including:

(i) Difficulty of handling due to health and safety regulations, which requires either very specific personal protective equipment or expensive direct injection mixing systems. In addition such systems can cause a slowing of the production rate.

(ii) Shortened ‘pot-life’ durations due to their rapid curing ability, creating reduced efficiency and potentially high wastage levels in the manufacturing environment. This manifests itself through the mix curing before it has been applied resulting in it being thrown away, problems in applying subsequent coats due to poor wetting of the previous surface, poor flowout, etc.

(iii) Often erratic adhesion values, particularly wet adhesion, especially on difficult to wet substrates with a low surface energy (e.g. waterproof leather, water resistant textiles, etc.). This creates issues such as (a) produced material that does not meet technical specifications, (b) limits the use of the material into certain high performance applications, and (c) problems in coating very water resistant fibrous bases, amongst others.

Embodiments of the present invention seek to overcome or alleviate at least some of these disadvantages.

According to one aspect the present invention provides a method of improving the adhesion of coatings to fibrous base materials, comprising:

i) treating a fibrous base material with one or more salt(s) of receptor species to provide a pre-coated fibrous base material comprising specific inorganic receptor sites within the fibrous base material, in which the one or more salt(s) of receptor species is selected from the groups comprising:

a) aluminium salts; b) titanium salts; c) zirconium salts; d) iron salts; and/or e) soluble alkali silicates; or a combination thereof; and

ii) coating the treated fibrous base material with a coating formulation comprising one or more compound(s) containing epoxy and alkoxysilane groups, in which the coating formulation acts as an adhesion promoter and cross-linker.

The one or more salts of receptor species may be, but are not limited to, metallic salt(s). The coating formulation may comprise one compound containing epoxy and alkoxysilane groups.

The fibrous base material is preferably composed of natural and/or synthetic fibres. The fibrous base material is treated with one or more salt(s) of receptor species, to provide essential receptor sites within the treated material. The fibrous base material is preferably treated during the final stage of production. The fibrous material can be treated with the salt(s) of receptor species for example during the pre-tanning, actual tanning or retanning processes of the fibrous base material, for example leather or synthetic leather processing. Alternatively, the salt(s) of receptor species can be provided as capping agents on hydrophobic fatliquoring auxiliaries of hydrophobing systems used to make water resistant fibrous base materials, such as for example water resistant leather or synthetic leather. The applicant has found that advantageously the use of hydrophobic lubricants which are capped with one or more salt(s) of receptor species, such as for example an aluminium, titanium or zirconium salt or a combination thereof, to create hydrophobicity also simultaneously and positively create specific receptor sites within the treated base material for enhanced adhesion to the coating formulation which comprises epoxy and alkoxysilane groups.

The substrate is then coated, as normal, employing one or more compound(s) containing epoxy and alkoxysilane groups, that will act as a cross-linker and adhesion promoter for aqueous based binders (e.g. polyurethane, acrylic, etc.), which specifically generate enhanced adhesion values through chemical bonding with the receptor sites applied to the fibrous base material. The epoxy ring offers reactivity to numerous organic functionalities, non-yellowing characteristics and generally enhanced flexibility of the cross-linked resins over traditional cross-linkers. The alkoxysilane aspect provides enhanced bonding to inorganic substances for enhanced adhesion characteristics, particularly aluminium.

Embodiments of the invention seek to overcome a number of weaknesses of existing systems by:

(i) Utilisation of a coating system that employs a compound containing epoxy and alkoxysilane groups, that will act as a cross-linker and adhesion promoter for aqueous based binders (e.g. polyurethane, acrylic, etc.), that has minimal implications regarding Health and Safety regulations, and therefore avoiding the need for specific personal protective equipment or the need for expensive direct injection mixing systems;

(ii) Utilisation of a compound containing epoxy and alkoxysilane groups that will act as a cross-linker and adhesion promoter for aqueous based binders (e.g. polyurethane, acrylic, etc.), that has a comparatively slower curing rates, thereby allowing less wastage of mixes and easier recoatability characteristics; and

(iii) By providing coatings with very good technical performance levels, especially wet and dry adhesion characteristics, to fibrous based substrates through the integration of certain salt(s) of receptor species that act as receptor sites. These receptor sites can be simple deposition or through a chemical bond ensuring their attachment to the fibres.

The method of the invention may involve two stages, a first stage and a second stage. The first stage may involve the treatment of the fibrous base material to provide a pre-coated fibrous base material comprising receptor sites within the fibrous base material. The fibrous base material may be composed of natural or synthetic fibres, or indeed both. The fibrous base material may be either non-woven, woven, hydro-entangled or created through some other method. The fibrous base material may comprise one or more of leather, synthetic leather or textiles (such as for example microfibre surfaces) or a combination thereof. Preferably, the fibrous base material comprises one or more of leather and synthetic leather, or a combination thereof. More preferably, the fibrous base material comprises leather.

The fibrous base material is treated with one or more salt(s) of receptor species selected from the groups comprising:

a) aluminium salts; b) titanium salts; c) zirconium salts; d) Iron salts; and/or e) soluble alkali silicates; or a combination thereof.

Preferably, the fibrous base material is treated with an aluminium salt. The one or more aluminium salt(s) are preferably selected from the group comprising aluminium sulphates, aluminium chlorides, aluminium formates, aluminium silicates and aluminium salts of fatty acids, or a combination thereof. A preferred example of aluminium formate is aluminium triformate. Examples of preferred aluminium salts of fatty acids include aluminium stearate and aluminium myristate. More preferably, the aluminium salt of fatty acids is aluminium stearate. An example of an aluminium silicate is an alkali aluminium silicate, preferably the aluminium silicate is sodium aluminium silicate. An example of a suitable aluminium silicate is sodium aluminium silicate such as Coratyl G as manufacture by Pulcra Chemicals.

Preferably the titanium and zirconium salts(s) are selected from sulphates, chlorides, salts of fatty acids, and silicates or a combination thereof. Examples of preferred titanium and zirconium salts of fatty acids include stearates and myristates. More preferably, the titanium and zirconium salts of fatty acids are stearates. Preferably the titanium and zirconium silicate is an alkali silicate.

Preferably the iron salt(s) are selected from iron chloride or iron sulphate, or a combination thereof.

The soluble alkali silicates may also be known as Wasserglass systems. Preferably, the soluble alkali silicate salt is sodium silicate.

Preferably, the fibrous base material is treated with one or more salt(s) of receptor species which are selected from aluminium, titanium, zirconium or iron salts, or combinations thereof. Preferably, the fibrous base material is treated with one or more of aluminium, titanium or zirconium salts, or combinations thereof. Preferably, the fibrous base material is treated with one or more metallic sulfates. For example, iron sulfate, aluminium sulfate, titanium sulfate, or zirconium sulfate, or a combination thereof. Preferably, the fibrous base material is treated with aluminium, titanium or zirconium sulfate, or a combination thereof. Preferably, the one or more salt(s) of receptor species comprises aluminium sulfate.

The fibrous base material may be treated with a minimum offer of at least about 0.1%, preferably at least about 1%, for example at least about 3%, by total mass of the salt(s) of receptor species based on the mass of the fibrous base material. Preferably, the maximum offer of the salt(s) of receptor species is no more than about 25%, preferably no more than about 15%, more preferably no more than about 10%, for example no more than about 6%, by total mass of the salt(s) of receptor species based on the mass of the fibrous base material. For example, the fibrous base material may be treated with an offer of between about 0.1% to about 25%; more preferably between about 1% to about 25%, preferably between about 1% to about 15%, for example between about 3% to about 6% by total mass of the salt(s) of receptor species based on the mass of the fibrous base material.

The fibrous base material may preferably be treated in a number of different ways, as follows:

i) the material may be treated by one or more salt(s) of receptor species of groups a) to e) as listed above in a pre-tanning, tanning or a re-tanning process;

ii) the material may be treated by one or more salt(s) of receptor species of groups a), b) and c) as capping compounds for hydrophobic fatliquors;

iii) the material may be treated at the final stage of wet processing by one or more salt(s) of receptor species of groups a) to e);

iv) by applying a solution containing the one or more salt(s) of the receptor species of groups a) to e) directly on/into the material.

The application of a solution containing the one or more salt(s) of the receptor species of groups a) to e) directly on/into the material may preferably be used when treating synthetic materials such as synthetic microfibers or textiles and reconstituted leathers (such as those created through hydroentanglement of waste leather fibres or reformed sheets of leather). The solution may be applied by any suitable coating/impregnation technique such as for example by rolling.

By treating the fibrous base material with salt(s) of receptor species, inorganic receptor sites are provided within the base material. By providing the salt(s) of receptor species as a capping agent of a hydrophobing system, the method has the dual effect of improving water resistance as well as providing inorganic receptor sites within the treated base material. Accordingly, in a further aspect of the invention, the fibrous base material may be treated with one or more salts(s) of receptor species selected from groups a), b) and c) as listed above or a combination thereof, in which the salt(s) of the one or more receptors are present as capping agents of a hydrophobing system during the process of preparing a water resistant fibrous base material, such as for example water resistant leather or synthetic leather.

An intermediate product comprising a pre-coated fibrous base material (herein referred to as a treated fibrous base material) is provided after treating the fibrous base material according to the first stage of the method of the invention. Accordingly, in a further aspect, the invention provides a pre-coated fibrous base material comprising specific inorganic receptor sites in which the receptor sites are provided by one or more salt(s) selected from a) aluminium salt(s), b) titanium salt(s); c)zirconium salt(s); d) iron salt(s), and/or e) soluble alkali silicates or a combination thereof.

The intermediate product comprising a pre-coated fibrous base material may have improved water resistance when the salt(s) of the receptor species is provided as a capping agent of a hydrophobing system in the manufacture of water resistant fibrous base material, such as for example water resistant leather or synthetic leather. The invention further provides a pre-coated fibrous base material comprising specific inorganic receptor sites in which the receptor sites are provided as a capping agent of a hydrophobing system, in which the receptor sites are provided by one or more salt(s) of selected from the groups a), b) and c) listed above, or combinations thereof. Preferably, the aluminium salts are selected from sulphates, chlorides, formate, silicates or fatty acids; or one or more titanium or zirconium salt(s) selected from sulphates, chlorides, fatty acids; or silicates, or combinations thereof. Preferably, the aluminium formate is aluminium triformate. Preferably, the aluminium silicate is sodium aluminium silicate. Preferably, the fatty acids are stearates or myristate. More preferably, the fatty acids are stearates.

At the end of a wet-stage of processing, such as for example at the end of a tanning/re-tanning process, of a fibrous base material, the fibrous material is immersed in an aqueous solution and chemical compounds can be applied and usually fixed through variation of temperature and pH values. Accordingly, in a further aspect of the invention the fibrous base material may be treated with one or more salt(s) of receptor species comprising at least one salt of groups a) to e) as discussed above, at the end of a wet-stage of processing, such as for example at the end of a tanning/re-tanning process.

The second stage of the method of the invention involves the use of specific adhesion promoters and cross-linking compounds which are based upon epoxy and alkoxysilane groups. As the coating formulation is prepared, whereby typical, although not limited to, coating formulations based upon resinous binders (e.g. polyurethane, acrylic, etc.) have a proportion of one or more compound(s) containing epoxy and alkoxysilane groups that will act as the adhesion promoter and cross-linker mixed within the formulation. Examples of suitable compounds containing epoxy groups and alkoxysilane groups, but not limited to include: 2-glycidoxyethyldimethylmethoxysilane; 6-glycidoxyhexyltributoxysilane; 3-glycidoxypropyltrimethoxysilane; 3-glycidoxypropyltriethoxysilane; 3-glycidoxypropylmethyldiethoxysilane; 5-glycidoxypentyltrimethoxysilane; 5-glycidoxypentyltriethoxysilane and 3-glycidoxypropyltriisopropoxysilane. Whilst all of these products have been found to improve the levels of wet and dry adhesion characteristics, it is noted that the 3-glycidoxyipropyl-trimethoxysilane with a suggested molecular formula of C9H20O5Si (also known by, but not limited to, the names of Gamma-Glycidoxypropyltrimethoxysilane; 3-(2,3-Epoxypropoxy)propyltrimethoxysilane; Glycidoxypropyltrimethoxysilane; Glymo; sigma-Glycidoxypropyltrimethoxysilane) compound proffers the best results. This product is currently marketed by Northants Leather Chemicals under the name of Norlink 600. Accordingly, the coating formulation preferably comprises 3-glycidoxypropyl-trimethoxysilane as a compound containing epoxy groups and alkoxysilane groups.

The resinous binders may be selected from the group comprising: polyurethane based dispersions, acrylic based dispersions, epoxy based dispersions and silicone based dispersions.

The treated fibrous base material may be treated with a minimum offer of compound(s) containing epoxy and alkoxysilane groups of about 0.05%, preferably about 0.5%, more preferably about 1% based upon the mass of the active content of the resinous binder component of the mix. The treated fibrous base material may be treated with a maximum offer of compound(s) containing epoxy and alkoxysilane groups of no more than about 15%, preferably no more than about 10%, for example no more than about 5% based upon the mass of the active content of the resinous binder component of the mix. For example, the treated fibrous base material may be treated with an offer compound(s) containing epoxy and alkoxysilane groups of in the region of between about 0.05% and about 15%, preferably in the region of between about 1% and about 5% based upon the mass of the active contents of the resinous binders.

The treated fibrous base material may be further treated with an optional sealer coat. The optional sealer coat may be applied after completion of the first stage of the method. Preferably, the sealer coat is applied after the first stage of the method. The sealer coat preferably comprises the epoxy/alkyloxysilane compound(s). The optional sealer coat may further include a small amount of a diluent, solvent, acrylic and/or polyurethane binders and auxiliaries that aid the flow and penetration of the mix.

The coating mixtures may be applied to the surface of the fibrous material through any suitable means of coating. Examples of relevant techniques, but not limited to, include spray coating, roller coating, curtain coating, etc. The coating may then be dried or semi-dried between application coats of the coating mixtures and layers may be built up as desired depending upon the final application.

The cross-linking and adhesion promotion characteristics are immediately apparent, although these properties are known to develop to their full extent over a period of 5-10 days.

The first and second stages of the method may be carried out consecutively. Preferably, the first and second stages of the method are carried out consecutively.

A product may be made wholly or partially of fibrous base material treated wholly or partially in accordance with an embodiment of the invention. The fibrous base material may be natural or synthetic, or a combination thereof. Examples of products made wholly or partially of fibrous base material include, but are not limited to, gloves, articles of footwear, articles of clothing, articles of upholstered seating and leather goods.

In a further embodiment, the invention provides a kit for improving the adhesion of coatings to a fibrous base material comprising: i) a first container comprising one or more salt(s) of receptor species for introducing specific inorganic receptor sites to the fibrous base material, in which the one or more salt(s) of receptor species is selected from the groups comprising:

a) aluminium salts; b) titanium salts; c) zirconium salts; d) iron salts; and/or e) soluble alkali silicates; or a combination thereof; and

ii) a second container comprising a coating formulation comprising one or more compound(s) containing epoxy and alkoxysilane groups.

The above and other characteristics, features and advantages of the present invention will become apparent from the following detailed description, taken in conjunction with the accompanying drawing, which illustrate, by way of example, the principles of the invention. This description is given for the sake of example only, without limiting the scope of the invention. The reference figures quoted below refer to the attached drawing.

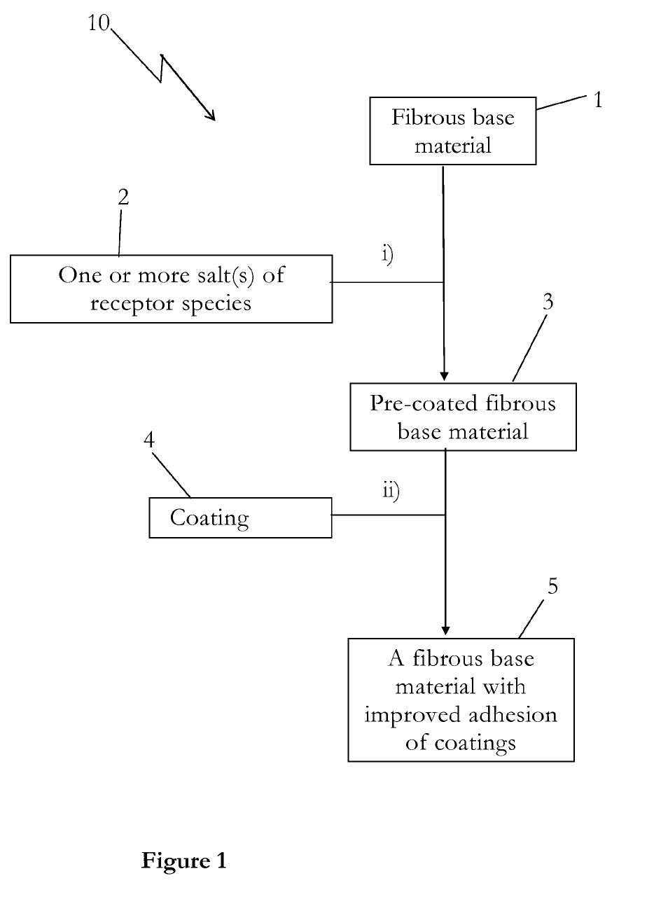

FIG. 1 is a flowchart of the method of an embodiment of the invention.

The present invention will be described with respect to particular embodiments but the invention is not limited thereto but only by the claims. The drawing described is only schematic and is non-limiting.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a method comprising steps A and B” should not be limited to devices consisting only of steps A and B. It means that with respect to the present invention, the only relevant steps of the method are A and B.

Reference throughout this specification to “one embodiment” or “an embodiment” means that a particular feature, method, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, methods, structures or characteristics of any embodiment or aspect of the invention may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may, in some embodiments, mean only one.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

As shown in FIG. 1, embodiments of the present invention provide a method 10 of improving the adhesion of coatings to fibrous base materials in which a fibrous base material 1 is first treated with one or more salt(s) of receptor species 2 to provide a precoated fibrous base material 3 which comprises specific inorganic receptor sites within the fibrous base material. The one or more salt(s) of receptor species 2 are selected from the groups comprising: aluminium salts, titanium salts, zirconium salts, iron salts; and/or soluble alkali silicates or a combination thereof. The treated fibrous base material 3 is then coated with a coating formulation 4 to provide a fibrous base material with improved adhesion of coatings 5. The coating formulation 4 comprises one or more compound(s) containing epoxy and alkoxysilane groups, in which the coating formulation acts as an adhesion promoter and cross-linker.

### EXAMPLE 1

### Hydrophobic Leather

A batch of previously tanned skins (using a conventional tanning process) is introduced into a treatment drum, together with an amount of treatment water. After the application and fixation of the typical retanning chemicals and hydrophobic fat-liquoring auxiliaries, a typical hydrophobic fatliquor is Pellan 602 manufactured by Pulcra, it is common to after treat with a metallic cation which confers hydrophobicity to the fibre structure of the leather. Typically in a fresh bath of water, with a volume typically 200% of the wet mass of the leather and at a temperature of 20 OC-40 OC, the pH is adjusted to a typical range of 3.0-5.0, more preferably 3.5-4.0. An offer of 0.5%-15% by mass, and more preferably 3%-6% by mass, of aluminium sulfate powder, based upon the wet tanned mass of the leather, is applied to the processing drum for a period of 30 minutes-240 minutes, depending upon the thickness of the leather and the degree of water resistance required. This stage allows the aluminium sulfate to penetrate the fibre structure and chemically bond to the hydrophobic fatliquor auxiliary to confer the water resistance characteristics. A preferred aluminium sulfate material is Norsyn GSA marketed by Northants Leather Chemicals Ltd, United Kingdom. The leather then undergoes at least one washing stage, preferably two or more, in order to wash away any residual chemicals from the retanning process.

The leather is then dried and mechanically softened, generally by, although not limited to, traditional means such as a vacuum dry operation and syncro staking operation, and ultimately prepared for coating.

As an option a sealer coat can be applied to the leather to create a primer coating to allow even better adhesion characteristics. Typically it will comprise of a small amount of a diluent, solvent, acrylic and/or polyurethane binders and auxiliaries that aid the flow and penetration of the mix together with one or more epoxy/alkoxysilane compounds, for example, but not limited to, Norlink 600 from NLC. Table 1 details a typical formulation:

TABLE 1
Table 1: Example Sealer Formulation

| | |
|---|---|
| 450 parts | Water |
| 375 parts | Solvent (e.g. Butyl Icinol) |
| 24 parts | Levelling agent (e.g. LA1621 from Stahl) |
| 150 parts | Acrylic and Polyurethane Binder Compact |
| | (e.g. Norcryl PN165 from NLC) |
| 1 parts | Epoxy functional alkoxysilane (e.g. |
| | Norlink 600 from NLC) |

The binders, auxiliaries, solvent and water are first combined with adequate mixing. The viscosity is adjusted as required, depending on the coating technique. The mixture is then cross-linked by adding the epoxy functional alkoxysilane with constant mixing for a period of five (5) minutes just prior to use. The sealer coating mixture is then applied wet to the leather surface utilising a variety of application techniques. A typical example, although not limited to, is through a padding operation. Typical application levels range from 0.1-20 grams per square foot, preferably 0.1-10 grams per square foot, more preferably 2-4 grams per square foot. The leather then passes through a drying tunnel, which uses a suitable form of drying heat such as, but not limited to, infra-red, to evaporate the water and solvents from the coating to form a thin dry continuous film.

A basecoat mixture is then prepared (see Table 2) whereby the chemicals employed are those normally used in leather finishing; with acrylic and polyurethane binders (of different solids contents and different particle sizes) as the main film forming constituents and pigments, waxes and auxiliaries also used. The binders, auxiliaries, pigments and water are first combined with adequate mixing. The viscosity is adjusted as required, depending on the coating technique. The mixture is then cross-linked by adding the epoxy functional alkoxysilane with constant mixing for a period of five (5) minutes just prior to use.

TABLE 2
Table 2: Example Basecoat Formulation

| | |
|---|---|
| 250 parts | Water |
| 200 parts | Pigment (e.g. from the Lepton FE range |
| | from BASF) |
| 9 parts | Wax (e.g. Lepton Wax CS from BASF) |
| 40 parts | Matting Agent (e.g. FI-50 from Stahl) |
| 250 parts | Acrylic Binder (e.g. Melio Resin A-946 |
| | from Clariant) |
| 250 parts | Polyurethane Binder (e.g. Northane 920 |
| | from NLC) |
| 1 parts | Epoxy functional alkoxysilane (e.g. |
| | Norlink 600 from NLC) |

The cross-linked coating mixture is then applied wet to the leather surface utilising a rollercoater. A typical roller coating machine capable of coating leather is sold and marketed by Gemata S.P.A as Starplus. Typical application levels range from 0.1-16 grams per square foot, more preferably 4-8 grams per square foot. The leather then passes through a drying tunnel, which uses a suitable form of drying heat such as infra-red, to evaporate the water and solvents from the coating to form a thin dry continuous film.

Further coats are the applied in the same fashion to build up further basecoats or complete the leather with a suitable topcoat system.

### EXAMPLE 2

### Non-Water Resistant Leather

A batch of previously tanned skins (using a conventional tanning process) is introduced into a treatment drum, together with an amount of treatment water. After the application and fixation of the typical retanning chemicals and fatliquoring auxiliaries, it is recommended to produce a final receptor species treatment, for example but not limited to cationic treatment, to the fibre structure. Typically in a fresh bath of water, with a volume typically 200% of the wet mass of the leather and at a temperature of 20 OC-40 OC, the pH is adjusted to a typical range of 3.0-5.0, more preferably 3.5-4.0. An offer of 0.5%-15% by mass, and more preferably 3% -6% by mass, of aluminium sulfate powder, based upon the mass of the leather, is applied to the processing drum for a period of 30 minutes-120 minutes, depending upon the thickness of the leather and the degree of water resistance required. This stage allows the aluminium sulfate to penetrate the fibre structure and chemically bond to fibre structure. A preferred aluminium sulfate material is Norsyn GSA marketed by Northants Leather Chemicals Ltd, United Kingdom. The leather then undergoes at least one washing stage, preferably two, in order to wash away any residual chemicals from the retanning process.

The leather is then dried and mechanically softened, generally by, although not limited to, traditional means, and ultimately prepared for coating. A basecoat mixture is then prepared (see Table 3) whereby the chemicals employed are those normally used in leather finishing; with acrylic and polyurethane binders (of different solids contents and different particle sizes) as the main film forming constituents and pigments, waxes and auxiliaries also used. The binders, auxiliaries, pigments and water are first combined with adequate mixing. The viscosity is adjusted as required, depending on coating technique. The mixture is then cross-linked by adding the epoxy functional alkoxysilane with constant mixing just prior to use.

TABLE 3
Table 3: Example Basecoat Formulation

| | |
|---|---|
| 250 parts | Water |
| 200 parts | Pigment (e.g. from the Lepton FE range |
| | from BASF) |
| 9 parts | Wax (e.g. Lepton Wax CS from BASF) |
| 40 parts | Matting Agent (e.g. FI-50 from Stahl) |
| 250 parts | Acrylic Binder (e.g. Melio Resin A-946 |
| | from Clariant) |
| 250 parts | Polyurethane Binder (e.g. Northane 920 |
| | from NLC) |
| 1 parts | Epoxy functional alkoxysilane (e.g. |
| | Norlink 600 from NLC) |

The cross-linked coating mixture is then applied wet to the leather surface utilising a rollercoater. A typical roller coating machine capable of coating leather is sold and marketed by Gemata S.P. A as Starplus. Typical application levels range from 0.1-16 grams per square foot, more preferably 6-8 grams per square foot. The leather then passes through a drying tunnel, which uses a suitable form of drying heat such as infra-red, to evaporate the water and solvents from the coating to form a thin dry continuous film.

Further coats are the applied in the same fashion to build up further basecoats or complete the leather with a suitable topcoat system.

### EXAMPLE 3

### Synthetic Leather Coating

A batch of manufactured synthetic microfiber sheet (as used in the production of synthetic leather) is passed through a roller coater which applies a solution of aluminium sulfate. An offer of 0.5%-15% by mass, and more preferably 3%-6% by mass, of aluminium sulfate powder, based upon the mass of the textile fibre (e.g. a microfiber), is applied to the surface of the textile. This stage allows the aluminium sulfate to penetrate the fibre structure and either chemically bond or simply deposit to fibre structure. A preferred aluminium sulfate material is Norsyn GSA marketed by Northants Leather Chemicals Ltd, United Kingdom. The synthetic microfibre is then dried and rolled ready for coating.

A coating mixture then prepared (see Table 4) whereby the chemicals employed are those normally used in synthetic fibre coatings; with acrylic and polyurethane binders (of different solids contents and different particle sizes) as the main film forming constituents and pigments, waxes and auxiliaries also used. The binders, auxiliaries, pigments and water are first combined with adequate mixing. The viscosity is adjusted as required, depending on coating technique. The mixture is then cross-linked by adding the epoxy functional alkoxysilane with constant mixing for a period of five (5) minutes just prior to use.

TABLE 4
Table 4: Example Synthetic Microfibre Coating Formulation

| | |
|---|---|
| 100 parts | Water |
| 100 parts | Pigment (e.g. from the Lepton FE range |
| | from BASF) |
| 7 parts | Wax (e.g. Lepton Wax CS from BASF) |
| 40 parts | Matting Agent (e.g. FI-50 from Stahl) |
| 250 parts | Acrylic Binder (e.g. Melio Resin A-946 |
| | from Clariant) |
| 500 parts | Polyurethane Binder (e.g. Northane 722 |
| | from NLC) |
| 3 parts | Epoxy functional alkoxysilane (e.g. |
| | Norlink 600 from NLC) |

The cross-linked coating mixture is then applied wet to the synthetic textile microfiber surface utilising a rollercoater. Typical application levels range from 0.1-25 grams per square foot, more preferably 6-8 grams per square foot. The leather then passes through a drying tunnel, which uses a suitable form of drying heat such as infra-red, to evaporate the water and solvents from the coating to form a thin dry continuous film.

Further coats are the applied in the same fashion to build up further basecoats or complete the leather with a suitable topcoat system.

### EXAMPLE 4

### Hydrophobic Leather with Zirconium Capping

A batch of previously tanned hides (using a conventional tanning process) is introduced into a treatment drum, together with an amount of treatment water. After the application and fixation of the typical retanning chemicals and hydrophobic fat-liquoring auxiliaries, such as Densodrin CD marketed by BASF Aktiengesellschaft, it is common to after treat with a metallic cation which confers hydrophobicity to the fibre structure of the leather. Typically in a fresh bath of water, with a volume typically 200% of the wet mass of the leather and at a temperature of 20 OC-30 OC, the pH is adjusted to a typical range of 2.5-4.0, more preferably 3.0-3.5 with citric acid. An offer of 0.5%-15% by mass, and more preferably 3%-6% by mass, of zirconium sulfate powder, based upon the wet tanned mass of the leather, is applied to the processing drum for a period of 30 minutes-240 minutes, depending upon the thickness of the leather and the degree of water resistance required. This stage allows the zirconium sulfate to penetrate the fibre structure and chemically bond to the hydrophobic fatliquor auxiliary to confer the water resistance characteristics. A preferred zirconium sulfate material is Norsyn GSZ marketed by Northants Leather Chemicals Ltd, United Kingdom. The leather then undergoes at least one washing stage, preferably two or more, in order to wash away any residual chemicals from the retanning process.

The leather is then dried and mechanically softened, generally by, although not limited to, traditional means such as a vacuum dry operation and syncro staking operation, and ultimately prepared for coating.

As an option a sealer coat can be applied to the leather to create a primer coating to allow even better adhesion characteristics. Typically it will comprise of a small amount of a diluent, solvent, acrylic and/or polyurethane binders and auxiliaries that aid the flow and penetration of the mix. Table 5 details a typical formulation:

TABLE 5
Table 5: Example Sealer Formulation

| | |
|---|---|
| 450 parts | Water |
| 375 parts | Solvent (e.g. Butyl Icinol) |
| 24 parts | Levelling agent (e.g. LA1621 from Stahl) |
| 150 parts | Acrylic and Polyurethane Binder Compact |
| | (e.g. Norcryl PN165 from NLC) |
| 1 parts | Epoxy functional alkoxysilane (e.g. |
| | Norlink 600 from NLC) |

The binders, auxiliaries, solvent and water are first combined with adequate mixing. The viscosity is adjusted as required, depending on the coating technique. The mixture is then cross-linked by adding the epoxy functional alkoxysilane with constant mixing for a period of five (5) minutes just prior to use. The sealer coating mixture is then applied wet to the leather surface utilising a variety of application techniques. A typical example, although not limited to, is through a padding operation. Typical application levels range from 0.1-20 grams per square foot, more preferably 2-4 grams per square foot. The leather then passes through a drying tunnel, which uses a suitable form of drying heat such as, but not limited to, infra-red, to evaporate the water and solvents from the coating to form a thin dry continuous film.

A basecoat mixture is then prepared (see Table 6) whereby the chemicals employed are those normally used in leather finishing; with acrylic and polyurethane binders (of different solids contents and different particle sizes) as the main film forming constituents and pigments, waxes and auxiliaries also used. The binders, auxiliaries, pigments and water are first combined with adequate mixing. The viscosity is adjusted as required, depending on the coating technique. The mixture is then cross-linked by adding the epoxy functional alkoxysilane with constant mixing for a period of five (5) minutes just prior to use.

TABLE 6
Table 6: Example Basecoat Formulation

| | |
|---|---|
| 275 parts | Water |
| 175 parts | Pigment (e.g. from the Neosan 2000 range |
| | from Clariant) |
| 9 parts | Wax (e.g. Lepton Wax CS from BASF) |
| 40 parts | Matting Agent (e.g. FI-50 from Stahl) |
| 300 parts | Acrylic Binder (e.g. Melio Resin A-946 |
| | from Clariant) |
| 200 parts | Polyurethane Binder (e.g. Northane 920 |
| | from NLC) |
| 1 parts | Epoxy functional alkoxysilane (e.g. |
| | Norlink 600 from NLC) |

The cross-linked coating mixture is then applied wet to the leather surface utilising a rollercoater. A typical roller coating machine capable of coating leather is sold and marketed by Gemata S.P.A as Starplus. Typical application levels range from 0.1-20 grams per square foot, more preferably 4-8 grams per square foot. The leather then passes through a drying tunnel, which uses a suitable form of drying heat such as infra-red, to evaporate the water and solvents from the coating to form a thin dry continuous film.

Further coats are the applied in the same fashion to build up further basecoats or complete the leather with a suitable topcoat system.

### EXAMPLE 5

### Non-Water Resistant Leather with Titanium End Treatment

A batch of previously tanned skins (using a conventional tanning process) is introduced into a treatment drum, together with an amount of treatment water. After the application and fixation of the typical retanning chemicals and fatliquoring auxiliaries, such as Coripol GA marketed by TFL AG, it is recommended to produce a final receptor species treatment to the fibre structure. Typically in a fresh bath of water, with a volume typically 200% of the wet mass of the leather and at a temperature of 20 OC-40 OC, the pH is adjusted to a typical range of 2.5-4.5, more preferably 3.5-4.0 with citric acid. An offer of 0.5%-15% by mass, and more preferably 3%-6% by mass, of titanium sulphate monohydrate powder, based upon the mass of the leather, is applied to the processing drum for a period of 30 minutes-120 minutes, depending upon the thickness of the leather and the degree of water resistance required. This stage allows the titanium sulfate to penetrate the fibre structure and chemically bond to fibre structure. A preferred titanium sulphate monohydrate material is Norsyn TSM marketed by Northants Leather Chemicals Ltd, United Kingdom. The leather then undergoes at least one washing stage, preferably two, in order to wash away any residual chemicals from the retanning process.

The leather is then dried and mechanically softened, generally by, although not limited to, traditional means, and ultimately prepared for coating. A basecoat mixture is then prepared (see Table 7) whereby the chemicals employed are those normally used in leather finishing; with acrylic and polyurethane binders (of different solids contents and different particle sizes) as the main film forming constituents and pigments, waxes and auxiliaries also used. The binders, auxiliaries, pigments and water are first combined with adequate mixing. The viscosity is adjusted as required, depending on coating technique. The mixture is then cross-linked by adding the epoxy functional alkoxysilane with constant mixing just prior to use.

TABLE 7
Table 7: Example Basecoat Formulation

| | |
|---|---|
| 250 parts | Water |
| 200 parts | Pigment (e.g. from the Lepton FE range |
| | from BASF) |
| 9 parts | Wax (e.g. Lepton Wax 16 from BASF) |
| 40 parts | Matting Agent (e.g. FI-50 from Stahl) |
| 250 parts | Acrylic Binder (e.g. Melio Resin A-946 |
| | from Clariant) |
| 250 parts | Polyurethane Binder (e.g. Bayderm |
| | Bottom DLV from Lanxess) |
| 1 parts | Epoxy functional alkoxysilane (e.g. |
| | Norlink 600 from NLC) |

The cross-linked coating mixture is then applied wet to the leather surface utilising a rollercoater. A typical roller coating machine capable of coating leather is sold and marketed by Gemata S.P. A as Starplus. Typical application levels range from 0.1-20 grams per square foot, more preferably 6-8 grams per square foot. The leather then passes through a drying tunnel, which uses a suitable form of drying heat such as infra-red, to evaporate the water and solvents from the coating to form a thin dry continuous film.

Further coats are the applied in the same fashion to build up further basecoats or complete the leather with a suitable topcoat system.

### EXAMPLE 6

### Non-Water Resistant Leather with Sodium Aluminium Silicate Main Tannage

A batch of pickled hides is introduced into a treatment drum, together with 100% (as based upon the pickled mass of the hides) of water at a temperature of 30 OC and common salt (NaCl) to avoid swelling. The pH is adjusted using both sulfuric and formic acid to ensure the cross-section of the hide reaches a range of 2.5-5.0, more preferably pH 3.0-3.5. An offer of 0.5%-15% by mass, and more preferably 6%-9% by mass, of sodium aluminium silicate powder, based upon the pickle mass of the leather, is applied to the processing drum for a period of 240 minutes-600 minutes, depending upon the thickness of the leather and the degree of tanning required. This stage allows the sodium aluminium silicate to penetrate the fibre structure and chemically bond to fibre structure. The pH automatically raises and consequently a self-basifying effect is observed. A preferred sodium aluminium silicate material is Coratyl G marketed by Pulcra Chemicals Ltd, Spain. The leather then undergoes at least one washing stage, preferably two, in order to wash away any residual chemicals from the tanning process. It is then further retanned and processed in a typical and conventional way.

The leather is then dried and mechanically softened, generally by, although not limited to, traditional means, and ultimately prepared for coating. A basecoat mixture is then prepared (see Table 8) whereby the chemicals employed are those normally used in leather finishing; with acrylic and polyurethane binders (of different solids contents and different particle sizes) as the main film forming constituents and pigments, waxes and auxiliaries also used. The binders, auxiliaries, pigments and water are first combined with adequate mixing. The viscosity is adjusted as required, depending on coating technique. The mixture is then cross-linked by adding the epoxy functional alkoxysilane with constant mixing just prior to use.

TABLE 8
Table 8: Example Basecoat Formulation

| | |
|---|---|
| 300 parts | Water |
| 100 parts | Pigment (e.g. from the Neosan 2000 range |
| | from Clariant) |
| 49 parts | Matting Agent (e.g. FI-50 from Stahl) |
| 200 parts | Acrylic Binder (e.g. Lepton Binder AE |
| | from BASF) |
| 300 parts | Polyurethane Binder (e.g. Norsol 840 |
| | from NLC) |
| 1 parts | Epoxy functional alkoxysilane (e.g. |
| | Norlink 600 from NLC) |

The cross-linked coating mixture is then applied wet to the leather surface utilising a sprayline. A typical sprayline coating machine capable of coating leather is sold and marketed by Carlessi S.P.A. Typical application levels range from 0.1-20 grams per square foot, more preferably 4-8 grams per square foot. The leather then passes through a drying tunnel, which uses a suitable form of drying heat such as infra-red, to evaporate the water and solvents from the coating to form a thin dry continuous film.

Further coats are the applied in the same fashion to build up further basecoats or complete the leather with a suitable topcoat system.

Although the invention has been described in detail in the foregoing for the purpose of illustration it must be understood that it is solely for that purpose and variations can be made by those skilled in the art without departing from the spirit and the scope of the invention except as it may be limited by its claims.

1. A method of improving the adhesion of coatings to fibrous base materials comprising: i) treating a fibrous base material with one or more salts(s) of receptor species to provide a treated fibrous base material comprising specific inorganic receptor sites within the fibrous base material, in which the one or more salt(s) of receptor species is selected from: a) aluminium salts; b) titanium salts; c) zirconium salts; d) iron salts; e) soluble alkali silicates; or a combination thereof; and ii) coating the treated fibrous base material with a coating formulation comprising one or more compound(s) containing epoxy and alkoxysilane groups, in which the coating formulation acts as an adhesion promoter and cross-linker.

2. A method as claimed in claim 1, in which the one or more salt(s) of the receptor species is applied during the pre-tanning, tanning or re-tanning of the fibrous base material.

3. A method as claimed in claim 1, in which the fibrous base material is composed of natural and/or synthetic fibres.

4. A method as claimed in claim 1, in which the fibrous base material is leather.

5. A method as claimed in claim 1, in which the fibrous base material is synthetic leather.

6. A method as claimed in claim 1, in which the fibrous base material is a textile.

7. A method as claimed in claim 1, in which the one or more salt(s) of a receptor species comprises an aluminium salt, a titanium salt or a zirconium salt or combination thereof.

8. (canceled)

9. (canceled)

10. (canceled)

11. A method as claimed in claim 7, wherein the titanium salt is selected from the group consisting of titanium sulphates, titanium chlorides, titanium silicates, titanium salts of fatty acids and a combination of the foregoing, the zirconium salt is selected from the group consisting of zirconium sulphates, zirconium chlorides, zirconium silicates, zirconium salts of fatty acids and a combination of the foregoing and the aluminum salt is selected from the group consisting of aluminium sulphates, aluminium chlorides, aluminium formates, aluminium silicates, sodium aluminium silicate, aluminium salts of fatty acids and a combination of the foregoing.

12. (canceled)

13. A method as claimed in claim 1, in which the iron salt is selected from the group consisting of, iron chlorides and iron sulphates.

14. (canceled)

15. A method as claimed in claim 1, in which the one or more salt(s) of a receptor species is a soluble alkali silicate(s)

16. A method as claimed in claim 15, in which the soluble alkali silicate(s) is selected from sodium silicate.

17. A method as claimed in claim 1, in which the one or more salt(s) of the receptor species is selected from one or more of groups (a), (b) and (c), or a combination thereof; and in which the one or more salt(s) is applied during a hydrophobic capping of the fibrous base materials.

18. (canceled)

19. (canceled)

20. A method as claimed in claim 1, in which the fibrous base material is treated with an offer in the range of 0.1% to 25% by total mass of the one or more salt(s) of a receptor species based on the mass of the fibrous base material.

21. (canceled)

22. A method as claimed in claim 1, in which the coating formulation further comprises a resinous binder selected from the group consisting of: polyurethane based dispersions, acrylic based dispersions, epoxy based dispersions and silicone based dispersions.

23. A method as claimed in claim 1, in which the one or more compound(s) containing epoxy and alkoxysilane groups is selected from the group consisting of: 2 glycidoxyethyldimethylmethoxysilane; 6 glycidoxyhexyltributoxysilane; 3 glycidoxypropyltrimethoxysilane; 3 glycidoxypropyltriethoxysilane; 3 glycidoxypropylmethyldiethoxysilane; 5 glycidoxypentyltrimethoxysilane; 5 glycidoxypentyltriethoxysilane and 3 glycidoxypropyltriisopropoxysilane, and a combination thereof.

24. (canceled)

25. A method as claimed in claim 1, in which the offer of the compound containing epoxy and alkoxysilane groups is in the range of between about 0.05% and about 15% by mas of the active contents of the resinous binders.

26. (canceled)

27. (canceled)

28. A natural of synthetic fibrous base material treated wholly or partially in accordance with the method of claim 1.

29. A kit for improving the adhesion of coatings to a fibrous base material comprising: i) a first container comprising one or more salt(s) of receptor species for introducing specific inorganic receptor sites to the fibrous base material, in which the one or more salt(s) of receptor species is selected from: a) aluminium salts; b) titanium salts; c) zirconium salts; d) iron salts; and/or e) soluble alkali silicates; or a combination thereof; and ii) a second container comprising a coating formulation comprising one or more compound(s) containing epoxy and alkoxysilane groups.
